(19) United States
(12) Patent Application Publication
(10) Pub. No.: US 2016/0066724 A1
(43) Pub. Date: Mar. 10, 2016

(54) DEVICE AND METHOD FOR MONITORING CONSUMER DINING EXPERIENCE

(71) Applicant: Intel Corporation, Santa Clara, CA (US)

(72) Inventors: Nicholas P. Cowley, Wroughton (GB); Ruchir Saraswat, Swindon (GB); Richard J. Goldman, Cirencester (GB); Chi Man Kan, Swindon (GB); Matthew T. Aitken, Swindon (GB); Colin L. Perry, Swindon (GB)

(21) Appl. No.: 14/483,023

(22) Filed: Sep. 10, 2014

(51) Int. Cl. A47G 21/06; G01P 15/00; G01C 19/00; G01K 13/00

(52) U.S. Cl. CPC A47G 21/06; G01K 13/00; G01P 15/00; G01C 19/00; A47G 2021/008

(57) ABSTRACT

Embodiments described herein relate generally to monitoring a dining session using smart smallwares. A smart smallware may sense usage or non-usage associated with a dining session of a customer. Based on the sensed non-usage of the smart smallware, the smart smallware may detect a period of inactivity. In response to the detected period of inactivity, the smart smallware may transmit an indication of the detected period of inactivity. This transmitted indication may cause an external monitoring device to notify a waitperson that a customer associated with that smart smallware may require attention. Other embodiments may be described and/or claimed.

### FIELD OF INVENTION

Embodiments of the present invention relate generally to the technical field of data processing, and more particularly, to smart smallwares, computer systems and methods adapted to operate to wirelessly communicate data over networks to monitor dining sessions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by their inclusion in this section.

In establishments serving foodstuffs, such as coffee shops, bars, restaurants, and the like, the revenue value associated with customer throughput is potentially negatively impacted by the ability to service customers in a timely manner. Both prompt servicing between courses and presentation of a bill to instigate patron turnover may be predominately controlled by the efficiency and observancy of the wait staff, either through passive monitoring of respective assigned patrons or by active requests for service by patrons. Intuitively, prompt and courteous service may enhance a patron's dining experience and, correspondingly, increase the likelihood that the patron will revisit and/or recommend the dining establishment, as well as improve the likelihood that the patron may increase a gratuity associated with the dining experience.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they may mean at least one.

FIG. 1 is a block diagram illustrating an environment for monitoring dining sessions of customers based on usage of smallwares, in accordance with various embodiments.

FIG. 2 is a block diagram illustrating a smallware adapted for monitoring a dining session, in accordance with various embodiments.

FIG. 3 is a block diagram illustrating a computing system for monitoring dining sessions based on smallwares, in accordance with various embodiments.

FIG. 4 is a flow diagram illustrating a method for monitoring dining sessions of customers based on usage of smallwares, in accordance with various embodiments.

FIG. 5 is a flow diagram illustrating a method for monitoring a dining session based on usage or non-usage sensed by a smallware, in accordance with various embodiments.

FIG. 6 is a flow diagram illustrating a method for monitoring a dining session based on at least one signal received from a smallware, in accordance with various embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group), and/or memory (shared, dedicated, or group) that execute one or more software or firmware programs, a combinational logic circuit, and/or other suitable hardware components that provide the described functionality.

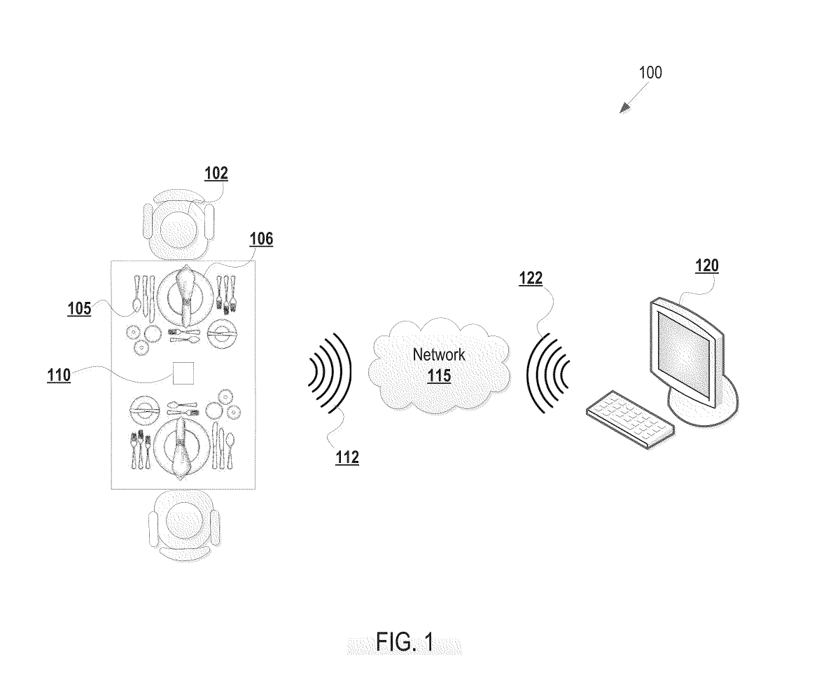

Beginning first with FIG. 1, a block diagram shows an environment 100 for monitoring dining sessions of customers or patrons through smart smallwares and associated computer systems, in accordance with various embodiments. The environment may include, but is not limited to, a plurality of smart smallwares 105, 106, an intermediate routing device 110, and an external monitoring external monitoring system 120, incorporated with the teachings of the present disclosure. Except for the teaching of the present disclosure integrated with some of the smart smallwares 105, 106 (hereinafter, simply smallwares), the smallwares 105, 106, in general, may be any type of smallwares suitable for serving, presentation, and/or consumption of comestibles by a customer 102 during a dining session. By way of example, a first smallware 105 may be a spoon, integrated with the teachings of the present disclosure, and a second smallware 106 may be a plate, integrated with the teachings of the present disclosure. In other embodiments, a smallware may be, for example, a knife, fork, bowl, cup, or the like, integrated with the teachings of the present disclosure.

According to embodiments, a first smallware 105 may be adapted to sense usage or non-usage of that smallware 105. Based on non-usage, the first smallware 105 may be adapted to detect a period of inactivity associated with a dining session of the customer 102. For example, as the customer 102 is engaged in consuming a course, the customer may move the first smallware 105. In response, the first smallware 105 may sense usage thereof and, correspondingly, the customer 102 may not need attention from a waitperson. When the customer 102 has completed that course, the customer may no longer move the first smallware 105. Accordingly, the first smallware 105 may be adapted to detect a period of inactivity that may indicate the customer 102 needs attention from a waitperson.

Similarly, a comestible served on a second smallware 106 may be served at a temperature that is appreciably greater than or less than room temperature. As the course is fresh, the second smallware 106 may detect a temperature that indicates the comestible is still approximately near a serving temperature. As the dining session continues, the temperature of the comestible served on the second smallware 106 may approach room temperature. Accordingly, the second smallware 106 may be adapted to detect a period of inactivity as the comestible served in the second smallware 106 is no longer acceptably close to a serving temperature, thereby indicating that the customer 102 needs attention from a waitperson.

In response to detections of periods of inactivity, the smallwares 105, 106 may be adapted to transmit radio signals to indicate the respective detections. The smallwares 105, 106 may transmit radio signals that are ultimately intended to alert a waitperson that the customer 102 needs attention. In various embodiments, these radio signals may be transmitted to an intermediate routing device 110. The intermediate routing device 110 may be, for example, a repeater. In other embodiments, the intermediate routing device 110 may be a radio node or other access node. The intermediate routing device 110 may provide a local cell for one or more smallwares 105, 106 associated with a first dining session, but may also provide a cell for other concurrent dining sessions (not shown), such as smallwares at other tables. Accordingly, a mesh of cells may be established to serve a dining establishment. The intermediate routing device 110 may reduce the transmission power required for the smallwares 105, 106 to transmit indications of detected periods of inactivity.

In various embodiments in which an intermediate routing device 110 is included, the smallwares 105, 106 may communicate data with the intermediate routing device 110 through, for example, a wireless local area network (“WLAN”) and/or a personal area network, such as Bluetooth, Flashlinq, radio-frequency identification (“RFID”), Wi-Fi Direct, infrared data association (“IrDA”), and the like. In some embodiments, this communication may adhere to at least one standard, such as a standard promulgated by the 3rd Generation Partnership Project (“3GPP”).

The indications of the detected periods of inactivity are to be wirelessly transmitted as radio signals 112 over a network 115. In various embodiments, the network 115 may be a WLAN or other similar short-range radio network. The radio signals 112 may be transmitted to an external monitoring system 120, which may be adapted to receive the radio signals 112 and resolve an indication of the customer 102 associated with the smallwares 105, 106 that caused the radio signals 112 to be transmitted over the network 115. In various embodiments, the external monitoring system 120 may be, for example, an external monitoring device that is adapted to provide a notification to a waitperson, based on one or more of the radio signals 112 received, that the customer 102 may require attention.

The external monitoring system 120 may be adapted to resolve that a customer 102 needs attention based on a plurality of smallwares. For example, as the customer 102 is engaged in consuming a course, the customer may move the first smallware 105 and another similar smallware (e.g., a knife and a fork), as when cutting a meat course into manageable bites at the beginning of a course. In response, both the first smallware 105 and the other smallware may sense usage thereof and, correspondingly, the customer 102 may not need attention from a waitperson. However, customer 102 may cease using the other smallware and only use the first smallware 102 when consuming the meat course. Even though the other smallware may detect a period of inactivity, the customer 102 may not need attention. The external monitoring system 120 may receive an indication of a detected period of inactivity from the other smallware, but the external monitoring system 120 may be adapted to determine that a notification should not be presented because the first smallware 105 has not indicated a detected period of inactivity. Accordingly, the external monitoring system 120 may aggregate information associated with a plurality of smallwares to determine if a notification should be presented to a waitperson.

According to embodiments, the external monitoring system 120 may be adapted to transmit radio signals 122 over the network 115 that are to cause the smallwares 105, 106 to begin detecting for a period of inactivity. The external monitoring system 120 may transmit these radio signals 122 to the smallwares 105, 106 through the intermediate routing device 110. According to embodiments, the external monitoring system 120 may transmit a plurality of radio signals 122 during a dining session associated with the customer 102 so that different periods of inactivity associated with different phases (e.g., courses) of a dining session may be monitored.

According to one embodiment, the external monitoring system 120 may be adapted to perform some operations associated with context. For example, the external monitoring system 120 may be adapted to observe durations of usages associated with the smallwares 105, 106 and may determine and/or adjust a period of inactivity based on the observed usage durations. In various embodiments, determinations and/or adjustments of a period of inactivity may be based on a predetermined algorithm that considers, for example, time of day, number of customers associated with a group or table, type of cuisine, and/or other factors. In an embodiment, the external monitoring system 120 may be adapted to adjust the period of inactivity based on, for example, usage of only one of the smallwares 105, 106—e.g., a customer 102 may be predisposed to using both smallwares 105, 106 or may use only one smallware 106 at the beginning of a course and the period of inactivity may be adjusted based on duration of usage of the one smallware 106. Therefore, the external monitoring device 120 may be adapted to perform some contextual awareness operations, for example, associated with the duration of the period of inactivity, the detection of the period of inactivity, and/or the calculation of the period of inactivity.

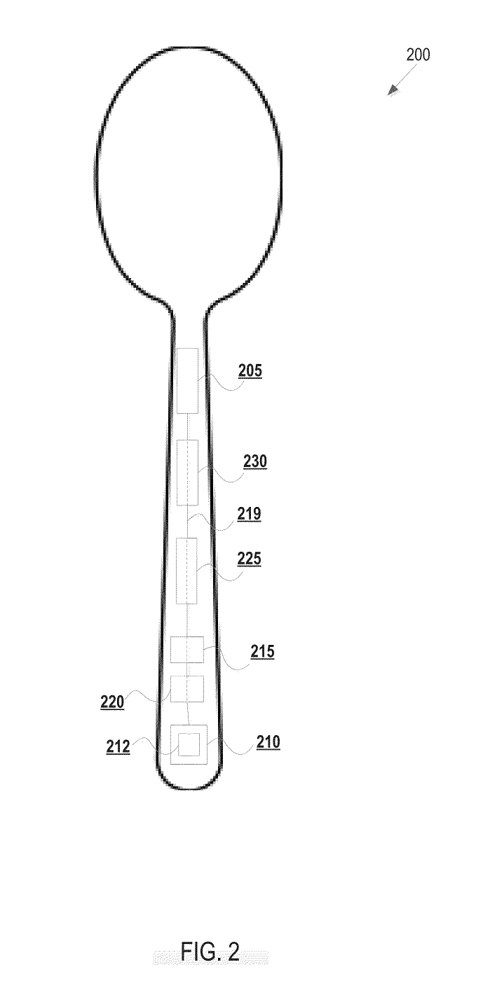

Turning now to FIG. 2, a block diagram illustrates a smallware 200 for monitoring dining, in accordance with various embodiments. The smallware 200 may be or may be included in one or both of the smallwares 105, 106 of FIG. 1. The smallware 200 illustrated in FIG. 2 may be a spoon. However, this illustration is to be understood as one example of a smallware 200 and is not to limit the embodiments described herein. In other embodiments, the smallware 200 may be, for example, a knife, fork, plate, bowl, cup, napkin, and the like. Accordingly, the smallware 200 may be any item that may be commonly associated with serving, presentation, and/or consumption of comestibles by a customer during a dining session.

The smallware 200 may include, but is not limited to, a sensor circuitry 205, processing circuitry 210, transmitter circuitry 215, receiver circuitry 220, one or more antennas 225, and/or a power supply 230. One or more of these components may be communicatively coupled through a bus 219. The bus 219 may be any subsystem adapted to transfer data within the smallware 200. The bus 219 may include a plurality of computer buses as well as additional circuitry adapted to transfer data within the smallware 200. In some embodiments, two or more of the circuitries 205-220 may be integrated with one another.

The sensor circuitry 205 may be adapted to sense usage of the smallware 200. The manner in which the sensor circuitry 205 is to sense usage of the smallware 200 may vary according to different embodiments. In one embodiment, the sensor circuitry 205 may be adapted to sense contact with the smallware 200. For example, the sensor circuitry 205 may include a thermometer or a thermistor so that usage may be sensed based on a change in temperature proximate to the smallware 200. In another example, the sensor circuitry 205 may include an electrostatic sensor and/or an electromagnetic sensor adapted to sense changes to electrostatic and electromagnetic fields, respectively, that may correspond to usage of the smallware 200 by a user (e.g., a customer). In a third example, the sensor circuitry 205 may include a plurality of conductive surfaces. In such an example, the conductive surfaces may be located on a housing of the smallware 200 that is proximate to a location at which a user is expected to grasp the smallware 200. The conductive surfaces may be adapted to sense an alteration of electrical resistance, electrical potential, and/or non-direct current potential that may correspond to usage of the smallware 200 by a user.

In another embodiment, the sensor circuitry 205 may be adapted to sense movement of the smallware 200. For example, the sensor circuitry 205 may include at least one of an accelerometer, a gyroscope, a vector magnetometer, and/or other means for sensing movement and/or orientation. In various embodiments, the sensor circuitry 205 may include a plurality of sensors—e.g., at least one sensor to sense usage based on movement of the smallware 200 and at least one other sensor to sense usage based on contact with the smallware 200.

The sensor circuitry 205 may be coupled with the processing circuitry 210. The sensor circuitry 205 may be adapted to output one or more signals and the processing circuitry 210 may be adapted to monitor the one or more signals outputted by the sensor circuitry 205. In one embodiment, the processing circuitry 210 may monitor the sensor circuitry 205 on a periodic basis, such as by polling the sensor circuitry 205. In another embodiment, the processing circuitry 210 may continuously monitor for one or more signals from the sensor circuitry 205. Based on one or more signals monitored by the processing circuitry 210, the processing circuitry 210 may be adapted to detect a period of inactivity that may be associated with a dining session. In one embodiment, the processing circuitry 210 may detect the period of inactivity based on the absence of one or more signals from the sensor circuitry 205. In another embodiment, the processing circuitry 210 may detect the period of inactivity based on one or more signals from the sensor circuitry 205 that are within a predetermined or expected range (e.g., a thermometer may output signals that are within an expected range that is approximately room temperature).

In one embodiment, the processing circuitry 210 may detect the period of inactivity based on one or more signals that are within a predetermined or expected range or just the absence of a monitored signal for a predetermined duration. The processing circuitry 210 may include or may be coupled with a timer 212. The processing circuitry 210 may start the timer 212 and monitor for one or more signals from the sensor circuitry 205. In one embodiment, the processing circuitry 210 may infer the period of inactivity when the timer 212 exceeds a set amount (e.g., at expiry of the timer 212). The processing circuitry 210 may restart the timer 212 based on one or more signals from the sensor circuitry 205 that indicate usage of the smallware 200, such as one or more signals that are outside of a predetermined or expected range or just the presence of one or more signals from the sensor circuitry 205.

The processing circuitry 210 may be adapted to begin detecting for a period of inactivity based on, for example, one or more received signals. Accordingly, the processing circuitry 210 may be coupled with receiver circuitry 220 to receive the one or more signals. In one embodiment, the receiver circuitry 220 may receive a signal from an external monitoring system (not shown), such as a “point-of-sale” system that is adapted to monitor dining sessions. In another embodiment, the receiver circuitry 220 may receive a signal from an intermediate routing device (not shown), such as a repeater or access node. According to one embodiment, the receiver circuitry 220 may receive a signal from an intermediate routing device when the smallware 200 is proximate to the intermediate routing device (e.g., when smallware 200 is placed at a space on a table that is collocated with the intermediate routing device). Based on the received signal, the processing circuitry 210 may be adapted to begin and/or restart detecting for a period of inactivity, such as by beginning or restarting the timer 212.

According to various embodiments, the received signal may include an indication of a duration for the timer 212. For example, the receiver circuitry 220 may receive a first signal that indicates a first duration for a first phase (e.g., course) of a dining session and, in response, the processing circuitry 210 may be adapted to set the timer 212 to run for that indicated first duration. Later in that same dining session, the receiver circuitry 220 may receive a second signal that indicates a second duration for a second phase (e.g., an entrée course) of that dining session and, in response, the processing circuitry 210 may set the timer 212 to run for that indicated second duration. At the end of a duration for the timer 212, the processing circuitry 210 may infer that the period of inactivity has been detected.

Based on a detected period of inactivity, the processing circuitry 210 may be adapted to cause the transmitter circuitry 215 to transmit at least one radio signal that is to indicate the detection of a period of inactivity. In various embodiments, the transmitter circuitry 215 may transmit this indication to an external monitoring system and/or an intermediate routing device for relay to the external monitoring system. Because the processing circuitry 210 may be adapted to detect a plurality of periods of inactivity associated with one dining session, the processing circuitry 210 may cause the transmitter circuitry 215 to transmit a plurality of indications that respectively correspond to a detected period of inactivity for a phase (e.g., course) of a dining session. In one embodiment, the processing circuitry 210 is adapted to include an indication of the dining session in the signal. For example, the processing circuitry 210 may include an address or other identifier that corresponds to a customer, space, table, and/or group associated with the dining session (although in some embodiments, an intermediate routing device may be adapted to supplement that radio signal with such an indication).

In various embodiments, the transmitter circuitry 215 and receiver circuitry 220 may include circuitry adapted for one or more protocols or interfaces. For example, the transmitter circuitry 215 and receiver circuitry 220 may include circuitry adapted for at least one of a wireless LAN and/or a personal area network. The transmitter circuitry 215 and receiver circuitry 220 may include circuitry adapted for one or more short-range communications, such as one or more of Bluetooth, Flashlinq, RFID, Wi-Fi Direct, IrDA, and the like. In some embodiments, the transmitter circuitry 215 and receiver circuitry 220 may include circuitry adapted for communication according to at least one standard, such as a standard promulgated by 3GPP.

The transmitter circuitry 215 and the receiver circuitry 220 may be coupled with one or more antennas 225. The one or more antennas 225 may enable wireless data communication over radio frequency. The one or more antennas 225 may be, for example, one or more patch antennas. In one embodiment, the one or more antennas 225 may be integrated with the sensor circuitry 205, such as in a conductive surface of the sensor circuitry 205. In another embodiment, the one or more antennas 225 may be embedded in a housing of the smallware 200. In such an embodiment, at least a portion of the housing of the smallware 200 would be traversable by radio signals. According to various embodiments, a plurality of antennas 225 may be arranged to provide beam shaping.

To power the components of the smallware 200, the smallware 200 may include a power supply 230. The power supply 230 may be, for example, a battery. The power supply 230 may be of sufficient capacity to power the components of the smallware 200 for an estimated lifetime of the smallware 200 (e.g., one year). In another embodiment, the power supply 230 may be rechargeable, such as through wireless charging. The processing circuitry 210 may be coupled with the power supply 230 and may be adapted to perform some power control and/or management functions. In some embodiments, the power supply 230 may be a piezoelectric generator, a motion and/or inertial charger, a solar charger, induction charger, and one or more transformers and/or capacitors.

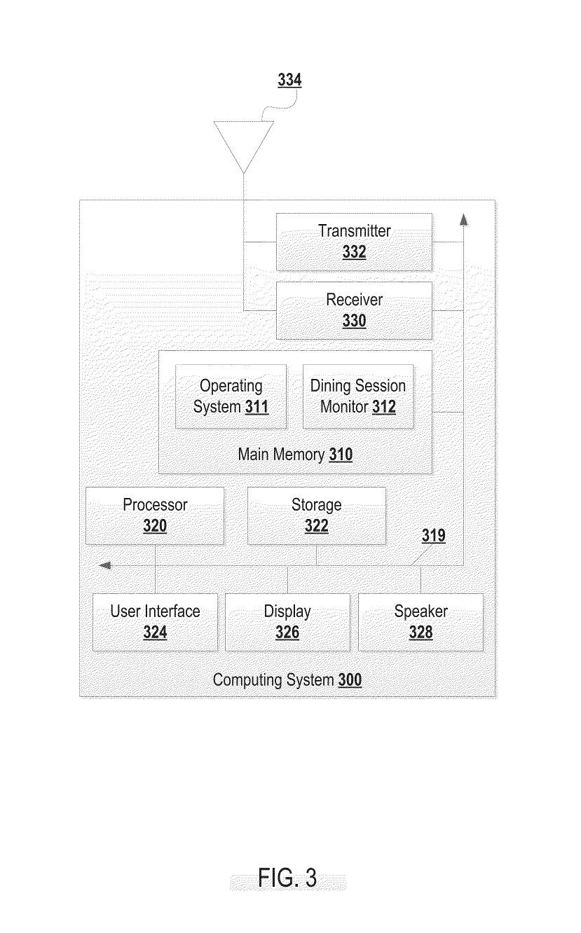

With respect to FIG. 3, a block diagram is shown illustrating a computing system 300 for monitoring a dining session, in accordance with various embodiments. The computing system 300 may be or may be included in the external monitoring system 120 of FIG. 1.

The computing system 300 may include, but is not limited to, main memory 310, storage 322, processor 320, a user interface 324, display 326, a speaker 328, a receiver 330, a transmitter 332, and/or at least one antenna 334. These components may be communicatively coupled through a bus 319. The bus 319 may be any subsystem adapted to transfer data within the computing system 300. The bus 319 may include a plurality of computer buses as well as additional circuitry adapted to transfer data within the computing system 300.

To communicate data with a smallware (not shown), the computing system 300 may include a receiver 330 and a transmitter 332. In the aggregate, the receiver 330 and transmitter 332 may be transceiver circuitry or communications circuitry according to some embodiments. The receiver 330 and transmitter 332 may be communicatively coupled with one or more antennas 334 to wirelessly transmit to and receive radio signals from one or more smallwares. In various embodiments, transmitted and/or received radio signals may be relayed to and from the respective receiver 330 and/or transmitter 332 by an intermediate routing device (e.g., a repeater or an access node). The receiver 330 and/or transmitter 332 may be implemented in hardware, software, or a combination of the two and may include, for example, components such as a network card, network access controller, and/or other network interface controller(s).

In various embodiments, the receiver 330 and transmitter 332 may include circuitry adapted for one or more protocols or interfaces. For example, the receiver 330 and transmitter 332 may include circuitry adapted for at least one of a wireless LAN and/or a personal area network. For example, the receiver 330 and transmitter 332 may include circuitry adapted for one or more short-range communications, such as one or more of Bluetooth, Flashlinq, RFID, Wi-Fi Direct, IrDA, and the like. In some embodiments, the receiver 330 and transmitter 332 may include circuitry adapted for communication according to at least one standard, such as a standard promulgated by 3GPP.

The processor 320 may be any processor suitable to execute instructions, such as instructions from the main memory 310. Accordingly, the processor 320 may be, for example, a CPU, a microprocessor, or another similar processor. In some embodiments, the processor 320 includes a plurality of processors, such as a dedicated processor (e.g., a graphics processing unit), a network processor, or any processor suitable to execute operations of the computing system 300. In embodiments, the processor 320 may be single core or multi-core, with or without embedded caches.

Coupled with the processor 320 is the main memory 310. The main memory 310 may offer both short-term and long-term storage and may in fact be divided into several units (including a unit located at the processor 320). The main memory 310 may be volatile, such as SRAM and/or DRAM, and may provide storage (at least temporarily) of computer-readable instructions, data structures, software applications, and other data for the computing system 300. Such data may be loaded from the storage 322. In embodiments, the main memory 310 may include non-volatile memory, such as Flash, EEPROM, and the like. The main memory 310 may also include cache memory, which may be in addition to cache located at the processor 320. The main memory 310 may include, but is not limited to, instructions related to an operating system 311, a dining session monitor 312 and any number of other applications that may be executed by the processor 320.

In various embodiments, the operating system 311 may be configured to initiate the execution of the instructions, such as instructions provided by the dining session monitor 312. In particular, the operating system 311 may be adapted to serve as a platform for running the dining session monitor 312. The operating system 311 may be adapted to perform other operations across the components of the computing system 300, including threading, resource management, data storage control, and other similar functionalities.

The operating system 311 may cause the processor 320 to execute instructions for the dining session monitor 312. In various embodiments, the dining session monitor 312 may comprise and/or may be communicatively coupled with a “point-of-sale” application (not shown) as is commonly found in dining establishments for entry and association of orders for comestible products with dining sessions. The dining session monitor 312 may include code representing instructions configured to cause the transmitter 332 to transmit radio signals to one or more smallwares and/or process radio signals received by the receiver 330 from one or more smallwares. Additionally, the dining session monitor 312 may be adapted to present, or cause to be presented, a notification. In one embodiment, the notification may be cognizable. For example, dining session monitor 312 may cause the display 326 to present a visual notification and/or cause the speaker 328 to emit an audible notification. In another embodiment, this notification may be a signal that causes another device to alert a waitperson—e.g., the dining session monitor 312 may cause the transmitter 332 to transmit a signal to a personal notification device associated with a waitperson who is to service a customer associated with a dining session. In other embodiments, the notification may be transmitted to a stationary service station or a mobile client device associated with a service person.

Based on at least one radio signal received from a smallware by the receiver 330, the dining session monitor 312 may cause the notification to be presented to indicate a period of inactivity has been detected by one or more of the smallwares. Thus, this notification may alert a waitperson that a customer associated with the one or more smallware needs attention. In various embodiments, the dining session monitor 312 may be adapted to resolve an indication of a specific dining session, such as a customer, space, table, group, or the like associated with the smallware that transmitted the radio signal. For example, a radio signal may include an indication of a smallware with which it is associated. In another embodiment, an intermediate routing device may include an indication of a customer, space, table, and/or group—e.g., the dining session monitor 312 may resolve a customer, space, table, and/or group based on an identifier included by an access node that is to relay signals from the smallware. Accordingly, the dining session monitor 312 may cause a notification to be presented that includes an indication of a dining session, such as a value associated with a customer, space, table, and/or group (e.g., a table number, a seat number, etc.).

In various embodiments, the dining session monitor 312 may cause the transmitter 332 to transmit at least one signal to a smallware. Such a transmitted radio signal may cause the smallware to begin monitoring for the period of inactivity associated with the dining session. For example, when a dining session and/or a phase thereof (e.g., a meal course) for a customer is initiated, the dining session monitor 312 may receive an input from a waitperson that causes the dining session monitor 312 to transmit a radio signal to the smallware to indicate that smallware is to begin monitoring for a period of inactivity. In various embodiments, the dining session monitor 312 may be adapted to transmit different radio signals that indicate different durations, such as a radio signal indicating a first duration for an entrée phase of a dining session and another radio signal indicating a second duration for a dessert phase. Therefore, the dining session monitor 312 may be adapted to transmit a plurality of radio signals for a plurality of phases (e.g., courses) of a single dining session.

According to embodiments, the dining session monitor 312 may be adapted to simultaneously and/or contemporaneously monitor a plurality of dining sessions. Thus, the dining session monitor 312 may process a plurality a radio signals received from a plurality of smallwares associated with a plurality of concurrent dining sessions. As described above, the dining session monitor 312 may be adapted to resolve an individual dining session of the concurrent dining sessions and present a notification of the individual dining session so that a waitperson may discern a customer and/or table that may require attention.

Similarly, the dining session monitor 312 may cause the transmitter 332 to contemporaneously transmit a plurality a radio signals to a plurality of smallwares associated with a plurality of concurrent dining sessions. Accordingly, the dining session monitor 312 may cause a plurality of smallwares to begin monitoring for periods of inactivity associated with a plurality of concurrent dining sessions. To cause the transmitter 332 to transmit a signal to the appropriate smallware, the dining session monitor 312 may resolve one or more smallwares associated with a dining session based on, for example, an address or identifier of the smallware over a network (e.g., a Bluetooth address or a Wi-Fi Direct address). In another embodiment, the dining session monitor 312 may transmit one or more signals to an intermediate routing device associated with a dining session, such as an access node associated with one table or space, and the intermediate routing device would then relay the signal to the one or more smallwares associated with that dining session.

According to one embodiment, the dining session monitor 312 may be adapted to perform some operations associated with context. For example, the dining session monitor 312 may be adapted to observe durations of usages associated with smallwares and may determine and/or adjust a period of inactivity based on the observed usage durations. In various embodiments, determinations and/or adjustments of a period of inactivity may be based on a predetermined algorithm that considers, for example, time of day, number of customers associated with a group or table, type of cuisine, and/or other factors. In an embodiment, the dining session monitor 312 may be adapted to adjust the period of inactivity based on, for example, usage of only one of the smallwares—e.g., a customer may be predisposed to using a knife and a fork simultaneously or may use the knife only at the beginning of a course and the period of inactivity may be adjusted based on duration of usage of the knife. Therefore, the dining session monitor 312 may be adapted to perform some contextual awareness operations, for example, associated with the duration of the period of inactivity, the detection of the period of inactivity, and/or the calculation of the period of inactivity. In one embodiment, the dining room session monitor 312 may observe durations of usages associated with smallwares by storing related information and, accessing the information, and adjusting a duration of a period of inactivity based on the accessed information (e.g., by calculation using a predetermined algorithm).

The computing system 300 may include a user interface 324 to receive input from a user, such as a waitperson. In various embodiments, the user interface 324 may be coupled with the dining session monitor 312. The dining session monitor 312 may cause the display 326 to present an indication of one or more dining sessions and then receive, through the user interface 324, a selection of one or more dining sessions that are to have one or more signals transmitted to the smallwares associated therewith. According to some embodiments, the dining session monitor 312 may receive, through the user interface 324, a selection that is associated with a duration of a period of inactivity associated with a dining session. For example, the dining session monitor 312 may cause the display 326 to present an indication of one or more phases associated with the dining session and then receive a selection of a phase. Based on such a received selection, the dining session monitor 312 may determine a duration of a period of inactivity that is to be transmitted to the smallware associated with that dining session.

The user interface 324 may allow a user to interact with the computing system 300 through various means, according to different embodiments—e.g., the user interface 324 may be presented to a user on a display 326 as a graphical user interface or through a command line interface. The user interface 324 may be implemented in hardware, software, or a combination of the two and may include or may be communicatively coupled with one or more hardware devices suitable for user input (e.g., a keyboard, mouse, or touch screen). Further, some or all of the instructions for the user interface 324 may be executed by the processor 320.

The display 326 may be any suitable device adapted to graphically present data of the computing system 300, such as a light-emitting diode (“LED”), an organic LED (“OLED”), a liquid-crystal display (“LCD”), an LED-backlit LCD, a cathode ray tube (“CRT”), or other display technology. According to some embodiments, the display 326 may be removably coupled with the computing system 300 by, for example, a digital visual interface cable, a high-definition multimedia interface cable, etc. Alternatively, the display 326 may be remotely disposed from computer system 300, e.g., associated with a stationary service station or a mobile client device of a service person.

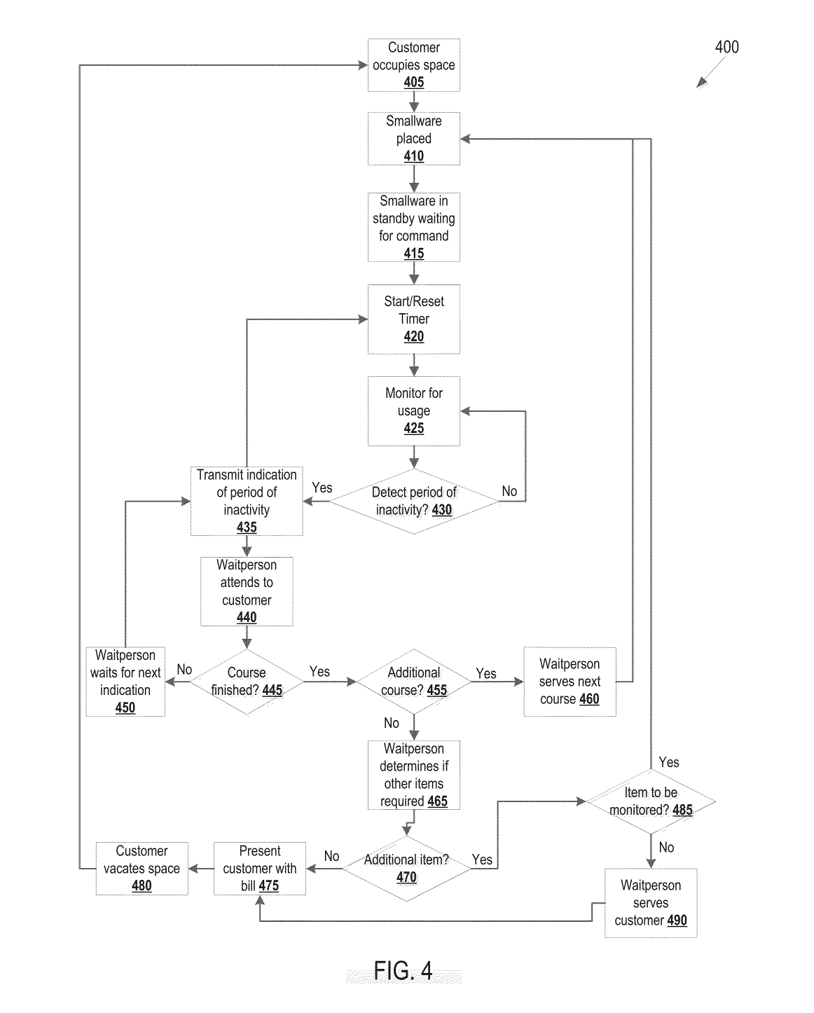

Turning to FIG. 4, this figure illustrates a method 400 for monitoring dining sessions of customers, in accordance with various embodiments. The method 400 may be performed in the environment 100 illustrated in FIG. 1, such as through the interaction of a smallware 105, 106 and the external monitoring system 120 over the network 115. While FIG. 4 illustrates a plurality of sequential operations, one of ordinary skill would understand that one or more operations of the method 400 may be transposed and/or performed contemporaneously.

As illustrated at operation 405, the method 400 may begin with occupying a space (e.g., a table, seat, place, etc.) by customer at a dining establishment. If not already present, operation 410 may include placing one or more smallwares at the space occupied by the customer. At least one of the one or more smallwares may be adapted to sense usage of that smallware and transmit a signal indicating at least one of usage and/or non-usage.

Operation 415 may include receiving an indication to begin monitoring the dining session, such as a command to begin monitoring a course of the dining session. According to various embodiments, the indication to begin monitoring the dining session may be a radio signal received over a network from a computer system (although this radio signal may be relayed through an intermediate routing device, such as an access node). In another embodiment, this indication may be based on a sensor associated with the smallware. For example, the sensor may sense an indication that the smallware is in use and subsequently receive this indication based on the sensor sensing that the smallware is not in use. Based on operation 415, the method 400 may include an operation 420 for beginning a timer associated with at least one of the smallwares that may indicate a period of inactivity.

While the timer is running, the method 400 may include an operation 425 for monitoring for an indication of usage. According to one embodiment, this operation 425 may include operations associated with monitoring one or more signals to be outputted by a sensor associated with the smallware. For example, operation 425 may include monitoring one or more signals that are within the predetermined range and continuing to run the timer based on the one or more signals that are within the predetermined range. Alternatively, operation 425 may include monitoring for an absence of one or more signals and continuing to run the timer based on the absence of the one or more signals. Further, operation 425 may include resetting the timer based on at least one monitored signal, such as a signal that is not within the predetermined range or simply the presence of a signal.

At decision block 430, the method 400 may include comparing a current value of the timer with a predetermined value that is to indicate a period of inactivity. As illustrated at decision block 430, if the current value of the timer does not indicate a period of inactivity, then the method 400 may return to operation 425 for monitoring for an indication of usage. However, if decision block 430 infers a period of inactivity based on the current value of the timer (e.g., if the current value of the timer meets the predetermined value or exceeds the predetermined value), then the method 400 may reach operation 435. Operation 435 may include transmitting an indication of a detection of a period of inactivity to a computing system. The computing system may be adapted to receive the indication and, in response, notify a wait staff, such as a waitperson who is to serve the customer occupying the space at which the smallware is placed. In various embodiments, this operation 435 may cause the timer to reset and again count toward a predetermined value. Operation 440 may include serving and/or attending to the customer who is occupying the space associated with the smallware.

Following operation 440, decision block 445 may include determining if the customer has completed a course of the dining session. If the customer has not completed the course, the method 400 may reach operation 450 for waiting, by the waitperson, for another indication of a detection of a period of inactivity. However, if it is determined that the customer has completed the course, the method 400 may reach decision block 455.

At decision block 455, the method 400 may comprise determining if the dining session is to include an additional course to be provided to the customer. If an additional course is to be provided to the customer, the method 400 may include an operation 460 for providing, by the waitperson, the next course. In various embodiments, this operation 460 may cause the method to return to operation 410. Accordingly, the method 400 may reach 415 for receiving an indication to begin monitoring the dining session. In some embodiments, the timer associated with operation 420 may be of different durations based on the different courses associated with the dining session.

If the determining associated with decision block 455 indicates that no further course is to be provided in the dining session, the method 400 may reach operation 465. Operation 465 may include determining, by the waitperson, if any additional items are to be provided to the customer. At decision block 470, the method 400 may include determining if the customer orders a further item. If the customer orders an additional item, then the method 400 may reach decision block 485.

Decision block 485 may comprise determining if the additional item is suitable for monitoring. For example, the additional item may be a bottled beverage wherein the bottle lacks a means for monitoring dining sessions and, therefore, the additional item may be unsuitable for monitoring. In various embodiments, decision block 485 may cause the method to return to operation 410 if the additional item is suitable for monitoring. Accordingly, the method 400 may reach 415 for receiving an indication to begin monitoring the dining session. In some embodiments, the timer associated with operation 420 may be of different durations based on the additional item associated with the dining session.

If the additional item is unsuitable for monitoring, the method 400 may reach operation 490 for serving, by the waitperson, the customer according to the additional item (e.g., providing a bottled beverage to the customer). Either following operation 490 or if decision block 470 indicates that the customer has not ordered an additional item, the method 400 may proceed to operation 475. At operation 475, the method 400 may include presenting, by the waitperson, a bill associated with the dining session to the customer. This operation 475 may indicate that the dining session has concluded and, therefore, operation 480 may include vacating, by the customer, the space. Subsequently, the method 400 may return to operation 405 for additional iterations through the method 400.

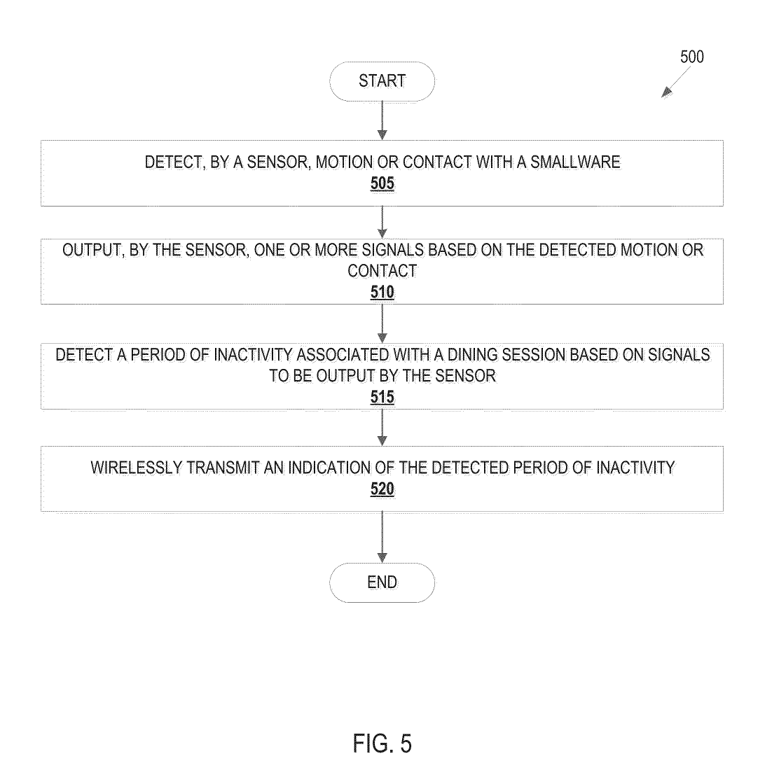

With respect to FIG. 5, a flow diagram illustrates a method 500 for monitoring dining by a smallware, in accordance with various embodiments. The method 500 may be performed by a smallware, such as a smallware 105, 106 of FIG. 1. While FIG. 5 illustrates a plurality of sequential operations, one of ordinary skill would understand that one or more operations of the method 500 may be transposed and/or performed contemporaneously.

To begin, the method 500 may include operation 505 for detecting motion or contact with a smallware. In various embodiments, detecting motion or contact may be performed by a sensor that is integrated with the smallware. According to the embodiment, the detecting of motion may be performed by, for example, an accelerometer, a gyroscope, a vector magnetometer, and/or other means for sensing movement and/or orientation. In other embodiments, the detecting of contact may be performed by, for example, a thermometer, a thermistor, an electrostatic sensor, an electromagnetic sensor, and/or a plurality of conductive surface to sense an alteration of electrical resistance, electrical potential, and/or non-direct current potential.

Based on the detecting of motion or contact with the smallware, operation 510 may include outputting, by the sensor, one or more signals in response to detection of motion or contact with the smallware. In one embodiment, the sensor may not output any signals based on non-usage of the smallware. In another embodiment, the sensor may output one or more signals based on non-usage of the smallware—e.g., a thermometer may perpetually or occasionally output a temperature value. However, one or more signals based on non-usage of the smallware may be within a predetermined and/or expected range associated with non-usage of the smallware. In one embodiment, the sensor may output one or more signals based on usage of the smallware such that the presence of the one or more signals indicates usage of the smallware. The sensor may output one or more signals based on usage of the smallware that are, for example, outside a predetermined and/or expected range.

In connection with operation 510, operation 515 may include detecting for a period of inactivity associated with the dining session. According to the embodiment, operation 515 may be based on receiving or non-receiving of the one or more signals output by the sensor. For example, an absence of signals may indicate inactivity; however, one or more signals within a predetermined and/or expected range may also indicate inactivity (e.g., a temperature signal that is within an expected room temperature range).

In various embodiments, operation 515 may include operations associated with beginning a timer that is to expire at a predetermined value. In one embodiment, this timer may begin based on a received signal, such as a radio signal received from an external monitoring device. Based on the receiving or non-receiving of the one or more signals output by the sensor, the period of inactivity may be detected at the expiration of the timer. However, a signal that indicates activity (e.g., a signal outside of a predetermined and/or expected range) may cause the timer to be reset.

From the detecting for the period of inactivity, the method 500 may include an operation 520 for wirelessly transmitting an indication of the detected period of inactivity. Transmitter circuitry integrated with the smallware may perform this operation 520. In various embodiments, the indication of the detected period of inactivity may be transmitted to an external monitoring device that is adapted to provide an alert to a waitperson so that the waitperson may promptly service a customer associated with that smallware. In some embodiments, the indication of the detected period of inactivity may be transmitted to an intermediary routing device (e.g., a repeater or access node) that is proximate to the smallware so that comparably less power may be required for transmission than may be commensurate with transmission to a more remote external monitoring device.

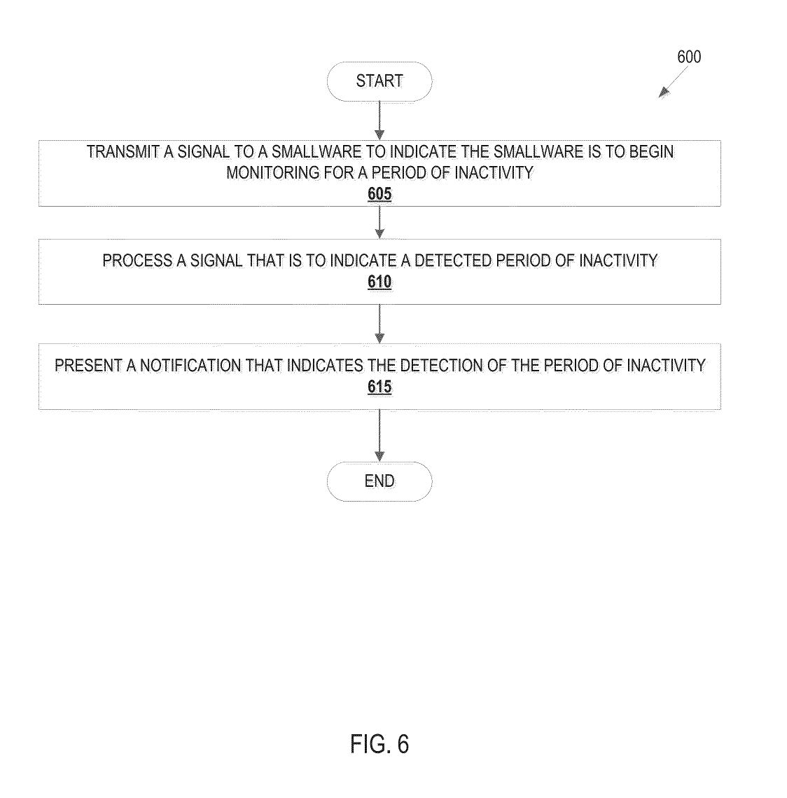

Now with reference to FIG. 6, a flow diagram illustrates a method 600 for monitoring a dining session and alerting a waitperson, in accordance with various embodiments. The method 600 may be performed by a computer system, such as an external monitoring system 120 of FIG. 1. While FIG. 6 illustrates a plurality of sequential operations, one of ordinary skill would understand that one or more operations of the method 600 may be transposed and/or performed contemporaneously.

The method 600 may include an operation 605 for transmitting at least one signal to a smallware. This signal may be a radio signal transmitted over a wireless network. The radio signal may indicate to the smallware that the smallware is to begin monitoring for a period of inactivity associated with the dining session. In various embodiments, this radio signal may be transmitted at the beginning of a customer's dining experience, such as when a customer is seated at a dining establishment. In another embodiment, this radio signal may be transmitted at the beginning of a course and, accordingly, a plurality of radio signals may be transmitted during a dining session to initiate monitoring of a plurality of courses.

In various embodiments, a computer system performing the method 600 may be associated with a plurality of smallwares and/or may be integrated or communicatively coupled with a “point-of-sale” system. Therefore, a plurality of signals may be transmitted to a plurality of smallwares associated with different customers and/or tables based on, for example, an address associated with a radio interface of a smallware. In some embodiments, a plurality of smallwares may be commonly addressable so that a plurality of smallwares associated with a table or group of customers may be signaled to begin monitoring for the period of inactivity.

The method 600 may include an operation 610 for processing one or more radio signals received from one or more smallwares that indicate one or more detected periods of inactivity associated with the one or more smallwares. In various embodiments, the one or more radio signals may be received from one or more of the smallwares or an intermediate routing device (e.g., a repeater or access node) that is proximate to the one or more smallware. According to some embodiments, the radio signal may indicate the dining session with which the one or more smallwares are associated. For example, the one or more radio signals may include an indication of a customer, table, and/or group associated with the dining session. In another embodiment, the one or more radio signals may indicate a waitperson associated with the dining session. Such an indication may be included at the one or more smallwares or at an intermediary routing device. In one embodiment, the computer system may be adapted to resolve the customer, table, and/or group associated with the dining session based on the one or more smallwares and/or intermediary routing device from which the at least one radio signal is received.

Based on the processing of the one or more radio signals, operation 615 may comprise presenting, or causing to be presented, a notification that indicates a period of inactivity associated with the dining session. A notification may vary according to embodiments. For example, operation 615 may comprise presenting a visual notification, such as an alert on a monitor associated with a “point-of-sale” system. In another embodiment, the operation 615 may comprise presenting an audio notification, such as a beep or audible tone. In even another embodiment, operation 615 may comprise causing a personal notification device associated with a waitperson (e.g., a smartphone or other wireless device adapted to receive radio signals) to present a vibrating notification, audio notification, and/or visual notification. According to various embodiments, a combination of notifications may be implemented. In some embodiments, this notification may include an indication of a customer, table, and/or group associated with the at least one radio signal upon which the notification is based. In response, a waitperson may attend to the customer associated with the detected period of inactivity upon which the at least one radio signal is based.

In various embodiments, example 1 may include an apparatus, to be included in a smallware, for monitoring dining, the apparatus comprising: sensor circuitry to sense usage of the smallware and output a signal to indicate usage or non-usage of the smallware; processing circuitry, coupled with the sensor circuitry, to monitor the signal and to detect for a period of inactivity of the smallware based on the monitoring of the signal; and transmitter circuitry, coupled with the processing circuitry, to transmit, in response to a detection of the period of inactivity, at least one radio signal to indicate the detection of a period of inactivity. Example 2 may include the apparatus of example 1, wherein the smallware is a knife, fork, spoon, plate, bowl, or cup. Example 3 may include the apparatus of example 1, wherein the sensor circuitry includes at least one conductive surface integrated with a housing of the smallware to generate the signal on contact. Example 4 may include the apparatus of example 1, wherein the sensor circuitry includes at least one of a thermometer, an accelerometer, or a gyroscope. Example 5 may include the apparatus of example 1, wherein the processing circuitry is to poll the sensor circuitry to monitor the signal. Example 6 may include the apparatus of any of examples 1-5, further comprising: a power supply coupled with at least one of the sensor circuitry, processing circuitry, or transmitter circuitry to respectively power the at least one of the sensor circuitry, processing circuitry, or transmitter circuitry, wherein the power supply is a selected one of a piezoelectric generator, a motion or inertial charger, a solar charger, induction charger, a transformer or a capacitor. Example 7 may include the apparatus of any of examples 1-5, further comprising: an antenna coupled with the transmitter circuitry. Example 8 may include the apparatus of example 7, further comprising: a plurality of antennas integrated with a housing of the smallware or embedded in the housing of the smallware. Example 9 may include the apparatus of any of examples 1-5, wherein the processing circuitry is to detect for the period of inactivity based on an absence of the monitored signal for a predetermined duration. Example 10 may include the apparatus of example 9, further comprising: a timer, coupled with the processing circuitry, to expire after a predetermined interval, wherein the processing circuitry is to restart the timer based on at least one monitored signal that is not within a predetermined range, and further wherein the processing circuitry is to infer the period of inactivity when the timer exceeds an amount. Example 11 may include the apparatus of example 10, further comprising: receiver circuitry, coupled with the processing circuitry, to receive another radio signal, wherein the processing circuitry is to start the timer based on receipt of the other radio signal. Example 12 may include the apparatus of any of examples 1-5, wherein the transmitter circuitry is to transmit the at least one radio signal over a personal area network or a wireless local area network. Example 13 may include the apparatus of any of examples 1-5, wherein the processing circuitry is to detect for a plurality of periods of inactivity associated with the smallware, and further wherein the transmitter circuitry is to transmit at least one respective radio signal based on a respective detected period of inactivity to indicate completion of a respective course of the dining session.

In various embodiments, example 14 may be a computer system for monitoring a dining session, the computer system comprising: a receiver to receive radio signals indicative of usage or absence of usage of one or more smallwares associated with the dining session; a dining session monitor to present, or cause to be presented, a notification to indicate a period of inactivity associated with the dining session based on the radio signals received. Example 15 may include the computer system of example 14, wherein the radio signals are received from at least one of a respective smallware or an intermediate routing device. Example 16 may include the computer system of example 14, wherein the dining session monitor is to present, or cause to be presented, the notification to at least one of a display or a speaker, and further wherein the computer system is communicatively coupled with at least one of the display or the speaker. Example 17 may include the computer system of any of examples 14-16, wherein the receiver is to receive the radio signals over a personal area network or a wireless local area network. Example 18 may include the computer system of any of examples 14-16, wherein the smallware is a knife, fork, spoon, plate, bowl, or cup integrated with sensor circuitry to sense usage, processing circuitry to cooperate with the sensor circuitry to detect inactivity, and transmitter to cooperate with the processing circuitry to transmit the radio signals. Example 19 may include the computer system of any of examples 14-16, wherein the dining session monitor is to cause a transmitter to transmit one or more signals to the one or more smallwares to cause the one or more smallwares to begin respective monitoring for inactivity of the one or more smallwares, and the computer system further comprising: the transmitter, communicatively coupled with the dining session monitor, to transmit the one or more signals to the one or more smallwares. Example 20 may include the computer system of example 19, wherein the dining session monitor is to determine a duration associated with the period of inactivity based on stored information, and further wherein the transmitter is to transmit an indication of the determined duration to the one or more smallwares for detection by the one or more smallwares.

In various embodiments, example 31 may be a method for monitoring a dining session, the method comprising: detecting, with a sensor integrated with a smallware used in the dining session, motion or contact with the smallware; outputting, by the sensor, one or more signals, in response to detection of motion or contact with the smallware; detecting for a period of inactivity associated with the smallware based on the receiving or non-receiving of the one or more signals; and wirelessly transmitting, to an external monitoring device, an indication of the detected period of inactivity. Example 22 may include the method of example 21, wherein detecting the period of inactivity based on the receiving or non-receiving of the one or more signals comprises: determining that at least one received signal is within a predetermined range; beginning a countdown timer integrated with the smallware based on the determining that the at least one received signal is within the predetermined range; and detecting the period of inactivity based on expiry of the countdown timer. Example 23 may include the method of any of examples 21-22, further comprising: receiving by the smallware an indication to begin the detecting of the period of inactivity. E

In various embodiments, example 24 may include be one or more non-transitory computer-readable media comprising computing device-executable instructions, wherein the instructions, in response to execution by a computing device, cause the computing device to: transmit at least one signal to a smallware to cause the smallware to begin monitoring for a period of inactivity associated with usage of the smallware; process at least one radio signal received from the smallware associated with inactivity of the smallware; present, or cause to be presented, a notification that indicates the period of inactivity associated with the dining session based at least in part on the at least one radio signal received from the smallware. Example 25 may include the one or more non-transitory computer system-readable media of example 24, wherein present or cause to be presented comprise present or cause to be presented the notification on a stationary service station or a mobile client device of a service person.

In various embodiments, example 26 may be one or more non-transitory computer-readable media comprising computing device-executable instructions, wherein the instructions, in response to execution by a smallware, cause the smallware to: sense usage of the smallware; output a signal to indicate usage or non-usage of the smallware; monitor the signal; detect for a period of inactivity of the smallware based on the monitoring of the signal; and transmit, in response to a detection of the period of inactivity, at least one radio signal to indicate the detection of a period of inactivity. Example 27 may include the one or more non-transitory computer-readable media of example 26, wherein the smallware is a knife, fork, spoon, plate, bowl, or cup. Example 28 may include the one or more non-transitory computer-readable media of example 26, wherein to monitor the signal comprises: to poll a sensor integrated with the smallware. Example 29 may include the one or more non-transitory computer-readable media of example 28, wherein the sensor includes at least one of a thermometer, an accelerometer, or a gyroscope. Example 30 may include the one or more non-transitory computer-readable media of any of examples 26-29, wherein to detect for the period of inactivity based on the monitoring of the signal comprises: to detect an absence of the monitored signal for a predetermined duration. Example 31 may include the one or more non-transitory computer-readable media of example 30, wherein to detect the absence of the monitored signal for a predetermined duration comprises to: begin a timer that is to expire after a predetermined interval; restart the timer based on at least one monitored signal that is not within a predetermined range; and infer the period of inactivity when the timer expires after the predetermined interval. Example 32 may include the one or more non-transitory computer-readable media of example 31, further comprising to: receive another radio signal; and begin the timer based on receipt of the other radio signal. Example 33 may include the one or more non-transitory computer-readable media of any of examples 26-32, wherein the transmission of the at least one radio signal is over a personal area network or a wireless local area network.

In various embodiments, example 34 may be a method for monitoring a dining session by a computer system, the method comprising: receiving radio signals indicative of usage or absence of usage of one or more smallwares associated with the dining session; presenting, or causing to be presented, a notification to indicate a period of inactivity associated with the dining session based on the received radio signals. Example 35 may include the method of example 34, wherein the radio signals are received from at least one of a respective smallware or an intermediate routing device. Example 36 may include the method of example 34, wherein the notification is at least one of an audible notification or a visual notification. Example 37 may include the computer system of any of examples 34-36, wherein the smallware is a knife, fork, spoon, plate, bowl, or cup integrated with sensor circuitry to sense usage, processing circuitry to cooperate with the sensor circuitry to detect inactivity, and transmitter to cooperate with the processing circuitry to transmit the radio signals.

In various embodiments, example 38 may be a smallware comprising: means for detecting, with a sensor integrated with the smallware used in a dining session, motion or contact with the smallware; means for outputting, by the sensor, one or more signals, in response to detection of motion or contact with the smallware; means for detecting for a period of inactivity associated with the smallware based on the receiving or non-receiving of the one or more signals; and means for wirelessly transmitting, to an external monitoring device, an indication of the detected period of inactivity. Example 39 may include the smallware of example 38, wherein the means for detecting for the period of inactivity based on the receiving or non-receiving of the one or more signals comprises: means for determining that at least one received signal is within a predetermined range; means for beginning a countdown timer integrated with the smallware based on the determining that the at least one received signal is within the predetermined range; and means for detecting the period of inactivity based on expiry of the countdown timer. Example 40 may include the smallware of any of examples 38-39, further comprising: means for receiving by the smallware an indication to begin the detecting of the period of inactivity.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the arts. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the invention also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine- (e.g., a computer-) readable storage medium (e.g., read only memory (“ROM”), random access memory (“RAM”), magnetic disk storage media, optical storage media, flash memory devices). Embodiments described herein may also include storage that is in a cloud (e.g., remote storage accessible over a network), which may be associated with the Internet of Things (“IoT”). In such embodiments, data may be distributed across multiple machines (e.g., computing systems and/or IoT devices), including a local machine.

The processes or methods depicted in the preceding figures can be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

In the foregoing Specification, embodiments of the invention have been described with reference to specific exemplary embodiments thereof. It will be evident that various modifications can be made thereto without departing from the broader spirit and scope of the invention as set forth in the following claims. The Specification and drawings are, accordingly, to be regarded in an illustrative sense rather than a restrictive sense.

What is claimed is:

1. An apparatus, to be included in a smallware, for monitoring dining, the apparatus comprising:
sensor circuitry to sense usage of the smallware and output a signal to indicate usage or non-usage of the smallware;
processing circuitry, coupled with the sensor circuitry, to monitor the signal and to detect for a period of inactivity of the smallware based on the monitoring of the signal; and
transmitter circuitry, coupled with the processing circuitry, to transmit, in response to a detection of the period of inactivity, at least one radio signal to indicate the detection of a period of inactivity.

2. The apparatus of claim 1, wherein the smallware is a knife, fork, spoon, plate, bowl, or cup.

3. The apparatus of claim 1, wherein the sensor circuitry includes at least one conductive surface integrated with a housing of the smallware to generate the signal on contact.

4. The apparatus of claim 1, wherein the sensor circuitry includes at least one of a thermometer, an accelerometer, or a gyroscope.

5. The apparatus of claim 1, wherein the processing circuitry is to poll the sensor circuitry to monitor the signal.

6. The apparatus of claim 1, further comprising:
a power supply coupled with at least one of the sensor circuitry, processing circuitry, or transmitter circuitry to respectively power the at least one of the sensor circuitry, processing circuitry, or transmitter circuitry, wherein the power supply is a selected one of a piezoelectric generator, a motion or inertial charger, a solar charger, induction charger, a transformer or a capacitor.

7. The apparatus of claim 1, further comprising:
an antenna coupled with the transmitter circuitry.

8. The apparatus of claim 7, further comprising:
a plurality of antennas integrated with a housing of the smallware or embedded in the housing of the smallware.

9. The apparatus of claim 1, wherein the processing circuitry is to detect for the period of inactivity based on an absence of the monitored signal for a predetermined duration.

10. The apparatus of claim 9, further comprising:
a timer, coupled with the processing circuitry, to expire after a predetermined interval, wherein the processing circuitry is to restart the timer based on at least one monitored signal that is not within a predetermined range, and further wherein the processing circuitry is to infer the period of inactivity when the timer exceeds an amount.

11. The apparatus of claim 10, further comprising:
receiver circuitry, coupled with the processing circuitry, to receive another radio signal, wherein the processing circuitry is to start the timer based on receipt of the other radio signal.

12. The apparatus of claim 1, wherein the transmitter circuitry is to transmit the at least one radio signal over a personal area network or a wireless local area network.

13. The apparatus of claim 1, wherein the processing circuitry is to detect for a plurality of periods of inactivity associated with the smallware, and further wherein the transmitter circuitry is to transmit at least one respective radio signal based on a respective detected period of inactivity to indicate completion of a respective course of the dining session.

14. A computer system for monitoring a dining session, the computer system comprising:
a receiver to receive radio signals indicative of usage or absence of usage of one or more smallwares associated with the dining session;
a dining session monitor to present, or cause to be presented, a notification to indicate a period of inactivity associated with the dining session based on the radio signals received.

15. The computer system of claim 14, wherein the radio signals are received from at least one of a respective smallware or an intermediate routing device.

16. The computer system of claim 14, wherein the dining session monitor is to present, or cause to be presented, the notification to at least one of a display or a speaker, and further wherein the computer system is communicatively coupled with at least one of the display or the speaker.

17. The computer system of claim 14, wherein the receiver is to receive the radio signals over a personal area network or a wireless local area network.

18. The computer system of claim 14, wherein the smallware is a knife, fork, spoon, plate, bowl, or cup integrated with sensor circuitry to sense usage, processing circuitry to cooperate with the sensor circuitry to detect inactivity, and transmitter to cooperate with the processing circuitry to transmit the radio signals.

19. The computer system of claim 14, wherein the dining session monitor is to cause a transmitter to transmit one or more signals to the one or more smallwares to cause the one or more smallwares to begin respective monitoring for inactivity of the one or more smallwares, and the computer system further comprising:
the transmitter, communicatively coupled with the dining session monitor, to transmit the one or more signals to the one or more smallwares.

20. The computer system of claim 19, wherein the dining session monitor is to determine a duration associated with the period of inactivity based on stored information, and further wherein the transmitter is to transmit an indication of the determined duration to the one or more smallwares for detection by the one or more smallwares.

21. A method for monitoring a dining session, the method comprising:
detecting, with a sensor integrated with a smallware used in the dining session, motion or contact with the smallware;
outputting, by the sensor, one or more signals, in response to detection of motion or contact with the smallware;
detecting for a period of inactivity associated with the smallware based on the receiving or non-receiving of the one or more signals; and
wirelessly transmitting, to an external monitoring device, an indication of the detected period of inactivity.

22. The method of claim 21, wherein detecting the period of inactivity based on the receiving or non-receiving of the one or more signals comprises:
determining that at least one received signal is within a predetermined range;
beginning a countdown timer integrated with the smallware based on the determining that the at least one received signal is within the predetermined range; and
detecting the period of inactivity based on expiry of the countdown timer.

23. The method of claim 21, further comprising:
receiving by the smallware an indication to begin the detecting of the period of inactivity.

24. One or more non-transitory computer-readable media comprising computing device-executable instructions, wherein the instructions, in response to execution by a computing device, cause the computing device to:
transmit at least one signal to a smallware to cause the smallware to begin monitoring for a period of inactivity associated with usage of the smallware;
process at least one radio signal received from the smallware associated with inactivity of the smallware;
present, or cause to be presented, a notification that indicates the period of inactivity associated with the dining session based at least in part on the at least one radio signal received from the smallware.

25. The one or more non-transitory computer system-readable media of claim 24, wherein present or cause to be presented comprise present or cause to be presented the notification on a stationary service station or a mobile client device of a service person.
